(19) United States
(12) Patent Application Publication
(10) Pub. No.: US 2005/0077105 A1
(43) Pub. Date: Apr. 14, 2005

(54) Escape ladder system

(76) Inventor: Chin-Piao Chang, Pingjhen City (TW)

Correspondence Address: TROXELL LAW OFFICE PLLC;SUITE 1404, 5205 LEESBURG PIKE, FALLS CHURCH, VA, 22041, US

(21) Appl. No.: 10/682,077

(22) Filed: Oct. 10, 2003

(51) Int. Cl. A62B 1/06

(52) U.S. Cl. 182/70

(57) ABSTRACT

An escape ladder system provided at a floor lever failing the reach by an aerial ladder truck is essentially comprised of an alarm to sense a fire hazard and sends warning signals, a receiver to receive fire alarm signals, a box placed by a balcony in a building tower to accommodate the receiver and other components, a driver activated by the receiver, a main shaft linked to the driver and a ladder coiling around the main shaft; the ladder being normally placed in the box; a fire being detected; the alarm being activated to transmit warning signals to the receiver; the power source being activated by the receiver; the main shaft being activated to turn around by a gear set; the escape ladder descending down along the external wall of the building down to the ground or a specific floor where is closer to the ground for people to soonest escape from the site on fire.

### BACKGROUND OF THE INVENTION

(a) Field of the Invention

The present invention is related to an escape ladder system, and more particularly, to one that is normally received in a box and descends down to the ground or a given floor along the external wall of the building through an opening of the box to allow people on higher floors in a building at where an aerial ladder truck fails to reach to fast escape from a fire site.

(b) Description of the Prior Art

More fire hazards have been reported on the increase recently, and the safety awareness of the general public is getting ever stronger. Among the concerns, how to fast escape from the fire site and provide first aid are on the top priorities. The general consumers are particularly concerned with the public safety concerns in entertainment places, such as KTV, MTV, cinema house, hotel, etc. where have reported increasingly higher casualties by year in fire hazards. Judging from the domestic statistics of fire hazard, most of them take place in buildings both of office and residential building where usually observed with highly populated rate and frequent accesses. Safety knowledge of fire fighting and fire escape naturally become the focuses of concerns by both of the tenants and fire safety inspection authorities.

However, escape gears provided in the buildings are very poor, if any. In most cases, only an emergency exit is provided to the window or the burglarproof window. If a fire breaks out, the people stuck in the fire site could only scramble around the exit waiting desperately for rescue, and many of them are forced to jump straight to the ground due to the unbearable heat resulting in serious casualties. Furthermore, the aerial ladder truck could best reach for approximately the twelfth level leaving those tenants working or living above the twelfth level helpless and they usually miss the best timing for escape and wind up falling on the ground to suffer serious bodily injury or even death.

### SUMMARY OF THE INVENTION

The primary purpose of the present invention is to provide an escape ladder system essentially comprised of an alarm to detect the fire and send the alarm signal, a receiver to receive the alarm signals, a box placed by a balcony to accommodate the receive and other components, a drive activated by a receiver, a main shaft driven by the driver, and an escape ladder coiling around the main shaft. The escape is normally placed in the box and in case of fire, the alarm installed in the room sends the alarm signals to the receiver in the box, the receiver commands the power source to operate for driving the main shaft to operate through a gear set for the escape ladder to descend from an opening of the box down to the ground or a certain floor that is close to the ground for the tenants in the higher levels at where the aerial ladder truck fails to reach to soonest escape upon the onset of the fire.

Furthermore, on the box at where opposite to the driver a cranking device is provided with a positioning rod that can be coupled to the main shaft on one side of a section of the cranking device penetrating into the box. If the power source fails due to power interruption or its battery is consumed up, the positioning rod is coupled to the main shaft to crank the main shaft for descending the escape ladder.

### BRIEF DESCRIPTION OF THE DRAWINGS

FIG. 1 is a schematic view showing a layout of a preferred embodiment of the present invention.

FIG. 2 is a schematic view showing a driver and a main shaft of the preferred embodiment of the present invention.

FIG. 3 is a perspective view showing that the preferred embodiment of the present invention is received in a box.

FIG. 4 is a schematic view showing that the preferred embodiment of the present invention is received in a box.

FIG. 5 is perspective view showing the appearance of the preferred embodiment of the present invention.

FIG. 6 is a schematic view showing a use status of an escape ladder of the preferred embodiment of the present invention.

FIGS. 7(A) and (B) are sectional views showing a cranking device and a main shaft of the preferred embodiment of the present invention.

### DETAILED DESCRIPTION OF THE PREFERRED EMBODIMENTS

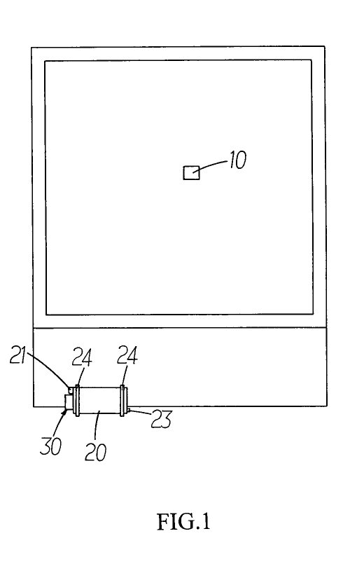

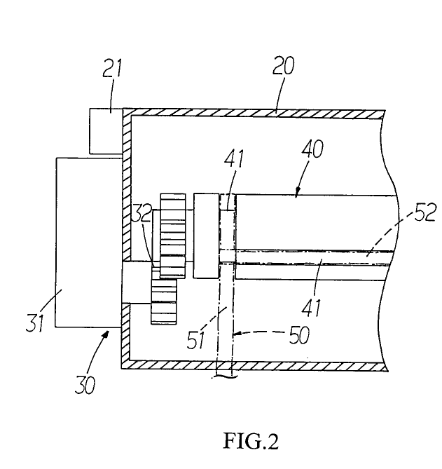

Referring to FIGS. 1 and 2, a preferred embodiment of the present invention is essentially comprised of a sensor (10), a box (20), a driver (30), a main shaft (40) and an escape ladder (50). Wherein, the sensor (10) is provided at where appropriately in a room to detect a fire hazard and to send the fire alarm signals to a receiver (21) provided in a box (20).

The box (20) located by a balcony and firmly resting on the floor includes the receiver (21) to receive fire alarm signals provided at where appropriately to the external of the box (20), an opening (22) provided at the front end of the box (20), and an alarm (23) to send visible or audible warning signals, and two hand rests (24) striding over both sides of the box (20) for the person escaping from the fire site to grab and/or step upon rungs (52) of an escape ladder (50). One ladder strap may be used with one end of the strap tying around the waist and the other end buckling up to either hand rest for further safety reason.

The main shaft (40) provided inside the box (20) is linked to the driver (30), and multiple locking grooves (41) are provided laterally and longitudinally on the surface of the main shaft (4) to allow coiling by the escape ladder (50).

The ladder (50) made of steel cable includes two side rails (51) and multiple rungs fixed between those two side rails (51). Multiple protrusions (521) for stopping slip are provided on each rung (52). One end of the escape ladder (50) is fixed to the main shaft (40) to allow the escape ladder (50) to coil around the main shaft (40) for being subject to the transmission from the driver (30). The length of the escape ladder (50) varies depending on the practical needs.

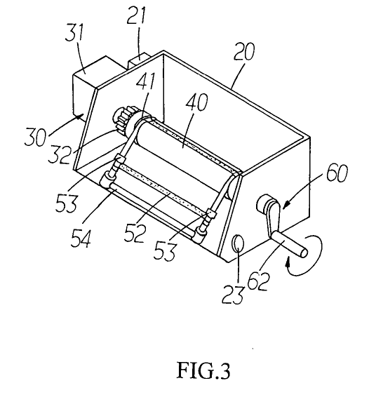

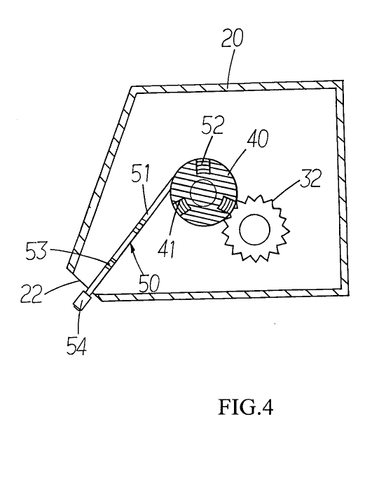

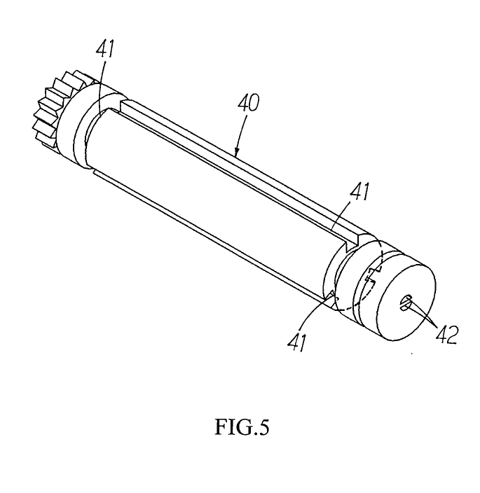

The escape ladder (50) is normally received in the box (50) as illustrated in FIG. 3. Referring to FIGS. 4 and 5, both side rails (51) and those multiple rungs (52) are respectively held in position in those locking grooves (41) laterally and longitudinally provided on the main shaft (40) when the escape ladder (50) coils around the main shaft (40) for being subject to the transmission from the driver (30) while the positioning status is detected by a sensor (53) provided at the terminal of the escape ladder (50).

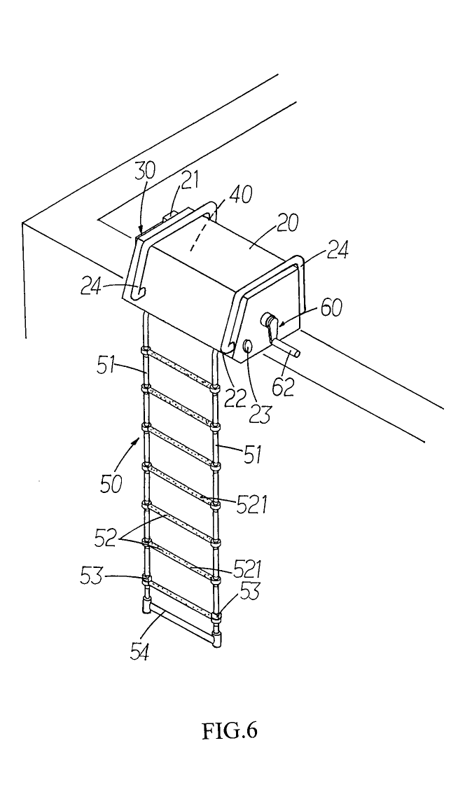

Accordingly, in case of a fire breaks out, the alarm (10) in the room sends alarm signals to the receiver (21) in the box (20) to command a power source (31) to activate for turning the main shaft (40) visa a gear set (32), thus to descend the escape ladder (50) through the opening (22) on the box (20) along the external wall down to the ground. Meanwhile, a gravity rod (54) is provided to the terminal of the escape ladder (50) to accelerate the escape ladder (50) to descend down to the ground as illustrated in FIG. 6.

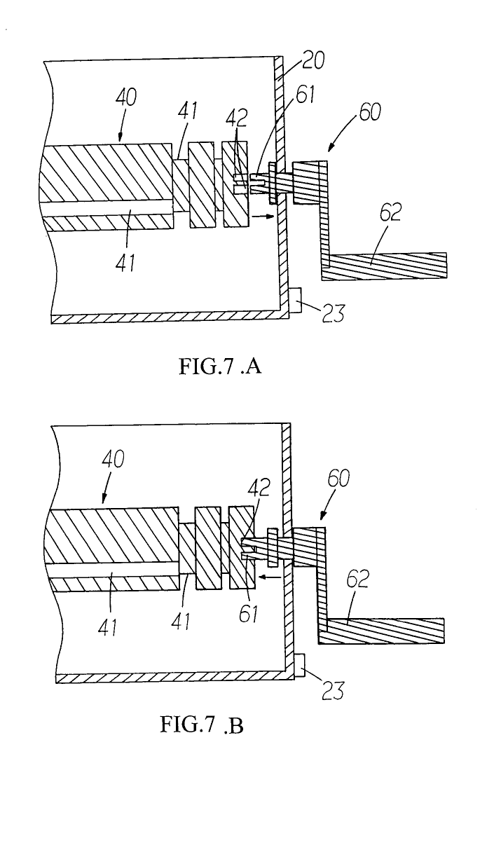

Furthermore, as illustrated in FIG. 7(A), a cranking device (60) is provided on the opposite to the driver (30) on the box (20) and a positioning rod (61) is provided by the side of the section of the cranking device (60) enters into the box (20) that can be locked to a positioning hole (42) provided on the main shaft (40), and a crank arm 62) is provided on the distal side of the positioning rod (61). In case the power source (31) is interrupted or the battery is consumed up, the cranking device (60) is coupled to the main shaft (40) by means of the positioning rod to operate the main shaft by using the crank arm (62) to descend the escape ladder (50) as illustrated in FIG. 7(B).

As described above, the present invention provides an escape ladder system that normally receives the escape ladder in the box and descends to the ground or a given floor closer to the ground along the external wall of a building through the opening of the box in case of a fire for the tenants on the higher floors where the aerial ladder trunk fails to reach to escape from the fire by climbing down on the escape ladder. Therefore, this application for a utility patent is filed according. However, it should be noted that the preferred embodiment described above of the present invention does not in anyway limit the scope of the present invention. Any change made by the teaching of the present invention shall be deemed as falling within the scope of the claim claimed in the present invention.

1. An escape fire ladder system including an alarm, a box, a driver, a main shaft and an escape ladder; wherein, the box being provided at where appropriately in a room to detect an onset of a fire and send alarm signals to a receiver; the box located by a balcony firmly resting on the ground, a receiver to receive the fire alarm being provided externally to the box at where appropriately, and an opening being provided to the front end of the box; the driver being provided at where appropriately on the box and linked to the main shaft to drive the main shaft; the main shaft provided inside the box being driven by the driver, and multiple locking grooves being provided laterally and longitudinally on the main shaft to hold the escape ladder coiled around the main shaft in position; and the escape ladder made of steel cable being comprised of two side rails and multiple rungs with one end of the escape ladder fixed to the main shaft; the escape ladder being driven by the driver to coil around the main shaft, and respectively held in position by those locking grooves laterally and longitudinally provided on the main shaft is characterized by that the escape ladder being normally received in the box; and in case of a fire, the alarm in the room detecting the fire and sending alarm signals to the receiver in the box, a power source being activated at the command of the receiver, the main shaft being driven through a gear set, the escape ladder descending through the opening of the box along the external wall of a building down to the ground or a given floor where being closer to the ground for those tenants on the higher floors in a building to fast escape from the fire site.

2. An escape ladder system as claimed in claim 1, wherein, the driver is comprised of a power source, a battery and a gear set.

3. An escape ladder system as claimed in claim 1, wherein, the power source of the driver is related to a motor.

4. An escape ladder system as claimed in claim 1, wherein, a cranking device is provide on the opposite side to the driver in the box, a positioning rod locked to the main shaft is provided on one side of the box, and a crank arm to crank the main shaft to descend the escape ladder in the absence of power supply.

5. An escape ladder system as claimed in claim 1, wherein, a gravity rod is provided to the terminal of the escape ladder to accelerate the escape ladder in descending down to the ground or a given floor where is closer to the ground.

6. An escape ladder system as claimed in claim 1, wherein, a positioning sensor is provided to the terminal of the escape ladder.

7. An escape ladder system as claimed in claim 1, wherein, an alarm sending visible or audible signals is provided to the box and linked to the sensor.

8. An escape ladder system as claimed in claim 1, wherein, two hand rests stride over both sides of the box to be grabbed by hand or buckled up with a S-type waist strap by a user to prevent from accidentally falling off the escape ladder.

9. An escape ladder system as claimed in claim 1, wherein, each rung is provided with multiple protrusions to stop slipping.
